(19) United States
(12) Patent Application Publication
(10) Pub. No.: US 2012/0159227 A1
(43) Pub. Date: Jun. 21, 2012

(54) POWER DETECTION DEVICE FOR MOTHERBOARD

(75) Inventors: SONG-LIN TONG, Shenzhen (CN); QI-YAN LUO, Shenzhen (CN); PENG CHEN, Shenzhen (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/070,491

(22) Filed: Mar. 24, 2011

(30) Foreign Application Priority Data
Dec. 15, 2010 (CN) 201010589251.X

(51) Int. Cl. G06F 1/26

(52) U.S. Cl. 713/340

(57) ABSTRACT

A motherboard detection device for a motherboard having a plurality of power input terminals. The power detection device includes a current sampling module, a voltage sampling module, a processor, and a display unit. The current sampling module is connected to the power input terminals for obtaining the current of each power input terminal. The voltage sampling module is connected to the power input terminals for obtaining the voltage of each power input terminal. The processor is connected to the current sampling module and the voltage sampling module for acquiring the current and the voltage of each power input terminal and calculating the input power of each power input terminal based on the current and the voltage of each power input terminal to obtain input power data. The display unit is connected to the processor for receiving the input power data from the processor and displaying the input power data.

### BACKGROUND

1. Technical Field

The present disclosure relates to a power detection device for a motherboard.

2. Description of Related Art

Many computer motherboards include multiple power input terminals connecting to output terminals on a power supply. It is necessary to determine the input power of the computer motherboard during design. Conventionally, the voltage and the current of each power input terminal is manually determined and input power of each power input terminal is calculated according to the result, a complicated and time consuming requirement.

What is needed, therefore, is a power detection device capable of overcoming the described limitations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments.

FIG. 1 is a schematic view of a power detection device according to an exemplary embodiment, together with a power supply and a motherboard.

FIG. 2 is a circuit diagram of a voltage sampling module and a current sampling module of the power detection device of FIG. 1, together with the power supply and the motherboard.

FIG. 3 is a circuit diagram of a first electronic switch of the power detection device of FIG. 1.

FIG. 4 is a circuit diagram of a second electronic switch of the power detection device of FIG. 1.

FIG. 5 is a circuit diagram of a processor of the power detection device of FIG. 1.

FIG. 6 is a circuit diagram of a liquid crystal display integrated circuit of the power detection device of FIG. 1.

### DETAILED DESCRIPTION

Embodiments of the present disclosure are described in detail as follows, with reference to the accompanying drawings.

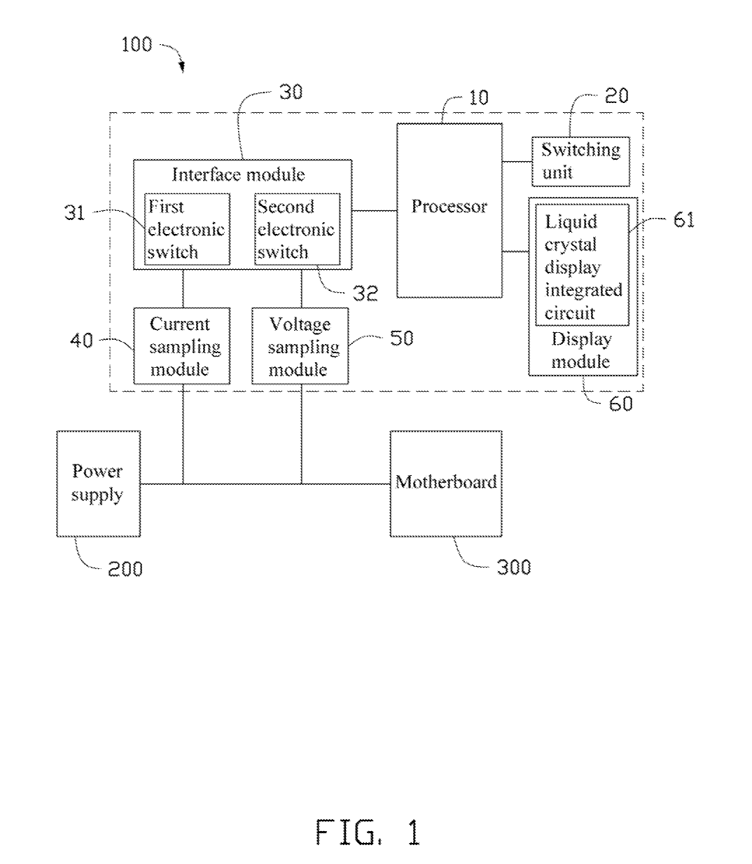

Referring to FIG. 1, a power detection device 100, according to an exemplary embodiment, is electrically connected between a power supply 200 and a motherboard 300. The motherboard detection device 100 includes a processor 10, a switching unit 20, an interface module 30, a current sampling module 40, a voltage sampling module 50, and a display unit 60.

The processor 10 is a microcontroller unit. In this embodiment, the processor 10 is a PIC16F73 microchip. The processor 10 is connected to the switching unit 20, the interface module 30, and the display unit 60. The interface module 30 is connected to the current sampling module 40 and the voltage sampling module 50. The current sampling module 40 and the voltage sampling module 50 are both connected to the power supply 200 and the motherboard 300.

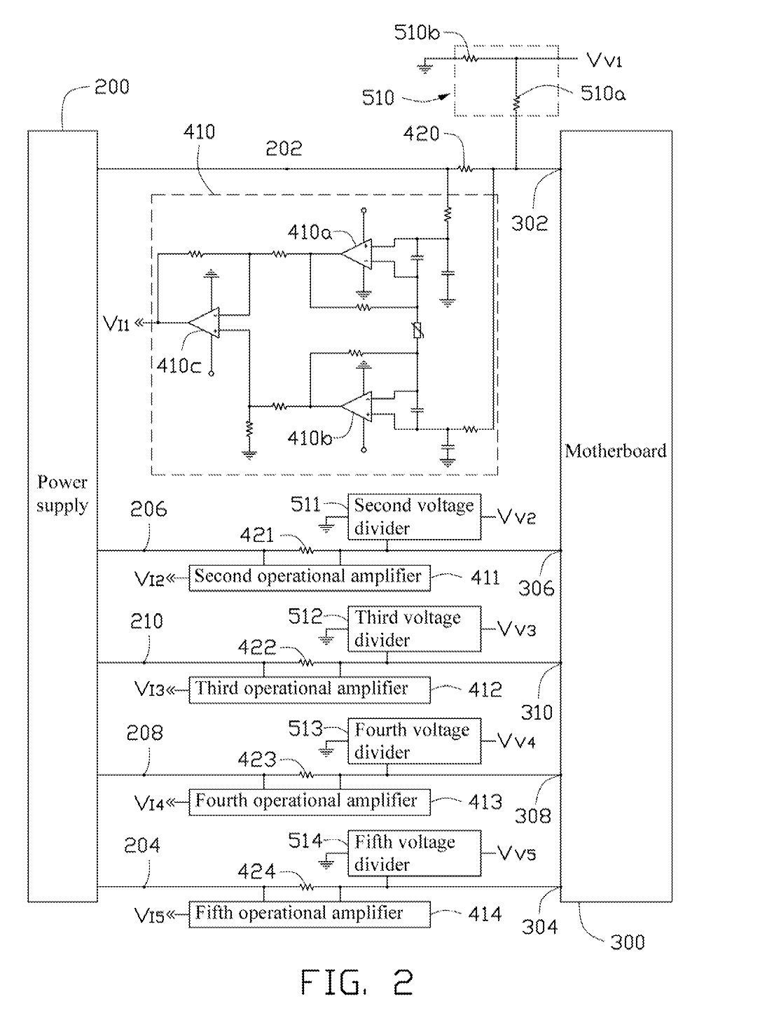

Referring to FIG. 2, the power supply 200 includes a first power output terminal 202, a second power output terminal 204, a third power output terminal 206, a fourth power output terminal 208, and a fifth power output terminal 210. The motherboard 300 includes a first power input terminal 302, a second power input terminal 304, a third power input terminal 306, a fourth power input terminal 308, and a fifth power input terminal 310. The current sampling module 40 includes a first, a second, a third, a fourth, and a fifth operational amplifiers 410, 411, 412, 413 and 414 and a first, a second, a third, a fourth, and a fifth Manganin wires 420, 421, 422, 423 and 424. The first Manganin wire 420 is electrically connected between the first power output terminal 202 and the first power input terminal 302. The second Manganin wire 421 is electrically connected between the second power output terminal 204 and the second power input terminal 304. The third Manganin wire 422 is electrically connected between the third power output terminal 206 and the third power input terminal 306. The fourth Manganin wire 423 is electrically connected between the fourth power output terminal 208 and the fourth power input terminal 308. The fifth Manganin wire 424 is electrically connected between the fifth power output terminal 210 and the fifth power input terminal 310.

In this embodiment, each of the first and second power output terminals 202, 204 is configured to provide a 12V power source, the third power output terminal 206 is configured to provide a 5V standby power source, the fourth power output terminal 208 is configured to provide a 5V power source, and the fifth power output terminal is configured to provide a 3.3V power source.

The first operational amplifier 410 detects and amplifies the voltage of the first Manganin wire 420 for the purpose of acquiring the current of the first power input terminal 202. The first operational amplifier 410 is a LM324DR microchip. The first operational amplifier 410 includes three sub-amplifiers 410a, 410b, 410c. The sub-amplifiers 410a and 410b calculate the voltage of the first Manganin wire 420, and the sub-amplifier 410c amplifies the voltage of the first Manganin wire 420 to acquire a first voltage V_{I1}. The first voltage V_{I1} is output to the interface module 30.

Each of the second, third, fourth and fifth amplifiers 411, 412, 413, 414 has the same structure as the first amplifier 410. Each of the second, third, fourth and fifth Manganin wires 421, 422, 423 and 424 has the same structure as the first Manganin wire 420. The second, third, fourth and fifth amplifiers 411, 412, 413, 414 are connected to the second, third, fourth and fifth Manganin wires 421, 422, 423, 424 correspondingly. The second, third, fourth and fifth amplifiers 411, 412, 413, 414 respectively output first voltages V_{I2}, V_{I3}, V_{I4}, V_{I5} to the interface module 30.

The voltage sampling module 50 includes a first, a second, a third, a fourth, a fifth voltage dividers 510, 511, 512, 513, 514 correspondingly connected to the first, second, third, fourth and fifth power input terminals 302, 304, 306, 308 and 310. The first voltage divider 510 includes two resistors 510a, 510b connected in series between the first power input terminal 302 and the ground, for creating and sending a second voltage V_{V1} to the interface module 30.

Each of the second, third, fourth and fifth voltage dividers 511, 512, 513 and 514 has the same structure as the first voltage divider 510. The second, third, fourth and fifth voltage dividers 511, 512, 513 and 514 are respectively configured to output second voltages V_{V2}, V_{V3}, V_{V4}, V_{V5} to the interface module 30.

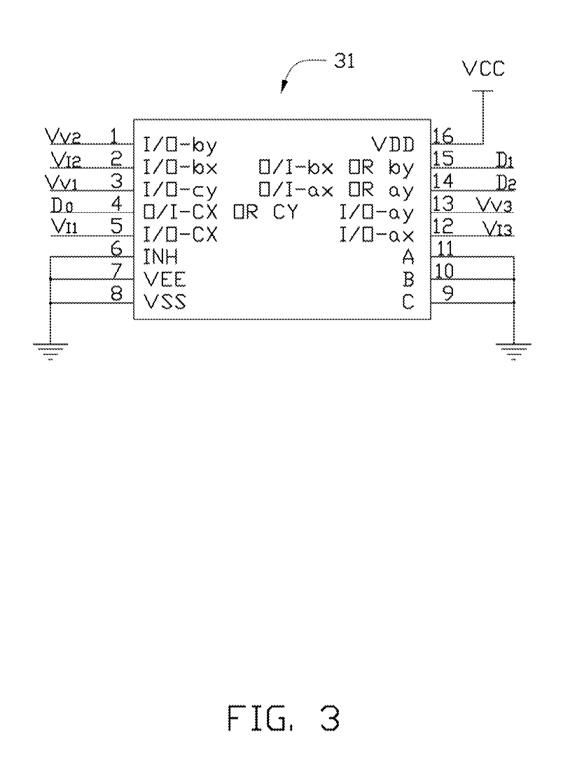

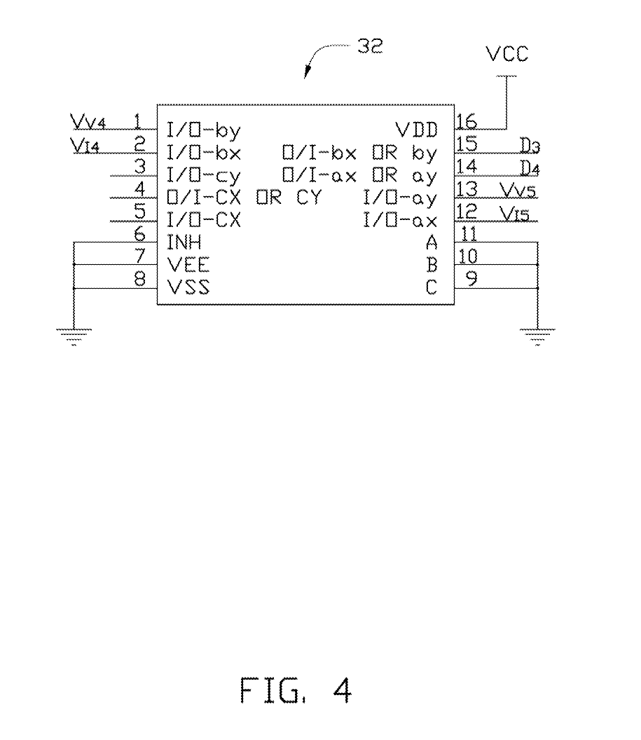

The interface module 30 converts the current sampling module 40 port and the voltage sampling module 50 port to the processor 10 port. The interface module 30 includes a first electronic switch 31 and a second electronic switch 32. Also referring to FIGS. 3 and 4, the first electronic switch 31 and the second electronic switch 32 are both CD4053BM96 microchips. Each first voltage and a corresponding second voltage both correspond to the same power input terminal and are output to a port of the processor 10 through one of the first and second electronic switches 31 and 31.

In this embodiment, the first voltage V_{I1} is output to a terminal 5 of the first electronic switch 31. The second voltage Vᵥ₁ is output to a terminal 3 of the first electronic switch 31. The first electronic switch 31 transmits the first voltage V_{I1} and the second voltage Vᵥ₁ from a terminal 4 thereof to the terminal RA0/AN0 of the processor 10 in order.

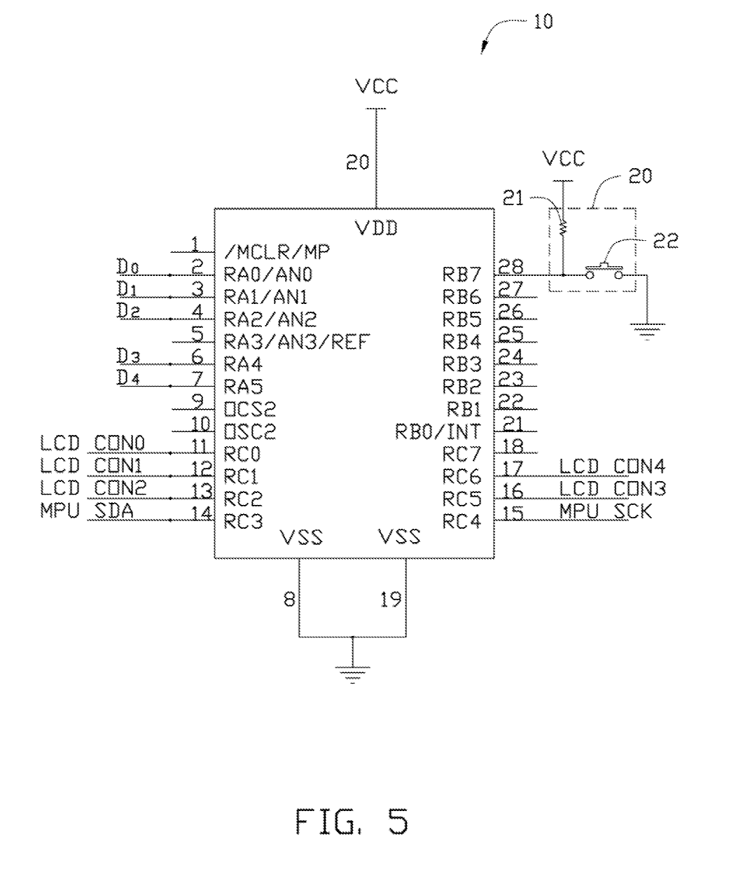

Also referring to FIG. 5, The first voltage V_{I2} is output to a terminal 2 of the first electronic switch 31. The second voltage Vᵥ₂ is output to a terminal 1 of the first electronic switch 31. The first electronic switch 31 transmits the first voltage V_{I2} and the second voltage Vᵥ₂ from terminal 15 thereof to the terminal RA1/AN1 of the processor 10 in order.

The first voltage V_{I3} is output to a terminal 12 of the first electronic switch 31. The second voltage Vᵥ₃ is output to a terminal 13 of the first electronic switch 31. The first electronic switch 31 transmits the first voltage V_{I3} and the second voltage Vᵥ₃ from a terminal 14 thereof to the terminal RA2/AN2 of the processor 10 in order.

The first voltage V_{I4} is output to terminal 2 of the second electronic switch 32. The second voltage Vᵥ₄ is output to a terminal 1 of the second electronic switch 32. The second electronic switch 32 transmits the first voltage V_{I4} and the second voltage Vᵥ₄ from a terminal 15 thereof to the terminal RA4 of the processor 10 in order.

The first voltage V_{I5} is output to terminal 12 of the second electronic switch 32. The second voltage Vᵥ₅ is output to the terminal 13 of the second electronic switch 32. The second electronic switch 32 transmits the first voltage V_{I5} and the second voltage Vᵥ₅ from the terminal 14 thereof to the terminal RA5 of the processor 10 in order.

The processor 10 controls the first electronic switch 31, the second electronic switch 32 through the terminals RA0/AN0, RA1/AN1, RA2/AN2, RA4 and RA5. The processor 10 calculates the input voltage of each power input terminal by: Uᵢ=Vᵥᵢ×(Rᵢ/Rᵢ₀), wherein Uᵢ is the input voltage of each power input terminal, V_{Vi} is the second voltage, Rᵢ is a total impedance of each voltage divider, Rᵢ₀ is a resistance of a resistor of each voltage divider connected to the ground, i=1, 2, 3, 4, 5. The processor 10 calculates the input current of each power input terminal by:

$${I}_{i} = \frac{{V}_{Ii}}{A \times {R}_{0}} ,$$

where Iᵢ is the input current of each power input terminal, V_{Ii} is the first voltage, A is an amplification factor of each amplifier, R₀ is a resistance of the Manganin wire 420, 421, 422, 423 or 424 of each power input terminal, i=1, 2, 3, 4, 5. The processor 10 calculates the input power of each power input terminal by: Pᵢ=Uᵢ×Iᵢ, the processor 10 calculates the total power of all power input terminals by: P=ΣPᵢ. The processor 10 outputs the input voltage, input current, input power of each power input terminal, and total power of all power input terminals to the display unit 60 to display.

The switching unit 20 is connected to the terminal RB7 of the processor 10. The switching unit 20 sends a starting signal to start the calculating process of the processor 10. In the present embodiment, the switching unit 20 includes a pull-up resistor 21 and a button switch 22. One pin of the button switch 22 is connected to the pull-up resistor 21 and the terminal RB7, and the other pin of the button switch 22 is connected to the ground. The terminal RB7 is connected to the ground when the button switch 22 is closed. When the terminal RB7 is connected to the ground, the processor 10 will calculate the result.

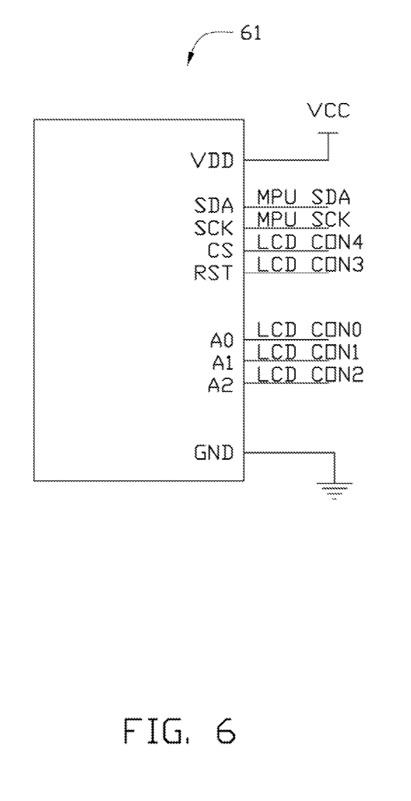

Referring to FIG. 6, the display unit 60 includes a liquid crystal display integrated circuit 61. The liquid crystal display integrated circuit 61 includes data pins A0-A2. The data pins A0-A2 are connected to the RC0-RC2 terminals of the processor 10 correspondingly and configured for receiving the calculation result.

While certain embodiments have been described and exemplified above, various other embodiments will be apparent to those skilled in the art from the foregoing disclosure. The present disclosure is not limited to the particular embodiments described and exemplified, and the embodiments are capable of considerable variation and modification without departure from the scope of the appended claims.

What is claimed is:

1. A power detection device for a motherboard, the motherboard comprising a plurality of power input terminals, the power detection device comprising:
a current sampling module for connecting to the power input terminals to obtain the current of each power input terminal;
a voltage sampling module for connecting to the power input terminals to obtain the voltage of each power input terminal;
a processor electrically connected to the current sampling module and the voltage sampling module, the processor being configured for acquiring the current and the voltage of each power input terminal and calculating the input power of each power input terminal based on the current and the voltage of each power input terminal to obtain input power data; and
a display unit connected to the processor, the display unit being configured for receiving the input power data from the processor and displaying the input power data.

2. The power detection device as claimed in claim 1, wherein the processor is configured for calculating a total input power by adding the input powers of all power input terminals and outputting the total input power to the display unit.

3. The power detection device as claimed in claim 1, wherein the processor is a micro controller unit.

4. The power detection device as claimed in claim 1, further comprising a switching unit connected to the processor and configured for sending a starting signal to the processor for actuating the processor to calculate.

5. The power detection device as claimed in claim 4, wherein the switching unit comprises a pull-up resistor and a button switch, one pin of the button switch is connected to the pull-up resistor and the processor, and another pin of the button switch is connected to the ground.

6. The power detection device as claimed in claim 1, wherein the current sampling module comprises a plurality of operational amplifiers and a plurality of Manganin wires, each Manganin wire is configured for being electrically connected between a corresponding power input terminal and a power supply, each amplifier is electrically connected to a corresponding Manganin wire and configured for amplifying the voltage of the corresponding Manganin wire, the processor is configured for acquiring the current of each power input terminal based on the amplified voltage and the resistance of each Manganin wire and the amplification factor of each amplifier.

7. The power detection device as claimed in claim 1, wherein the voltage sampling module comprises a plurality of voltage dividers, each voltage divider is configured for connecting to a corresponding power input terminal to generate a divided voltage.

8. The power detection device as claimed in claim 7, wherein each voltage divider comprises two resistors connected in series between the corresponding power input terminal and the ground.

9. The power detection device as claimed in claim 1, further comprising an interface module connecting the current sampling module and the voltage sampling module to the processor.

10. The power detection device as claimed in claim 9, wherein the interface module comprises two electronic switches, with each electronic switch connecting the current sampling module and the voltage sampling module to the processor.
